(19) United States
(12) Patent Application Publication
(10) Pub. No.: US 2025/0285531 A1
(43) Pub. Date: Sep. 11, 2025

(54) Wearable Safety and Emergency Response Device

(71) Applicant: Jessica Simpson, Cranston, RI (US)

(72) Inventor: Jessica Simpson, Cranston, RI (US)

(21) Appl. No.: 18/751,454

(22) Filed: Jun. 24, 2024

Related U.S. Application Data
(60) Provisional application No. 63/561,773, filed on Mar. 6, 2024.

(51) Int. Cl. G08B 25/12; G04G 21/04

(52) U.S. Cl. CPC G08B 25/12; G04G 21/04

(57) ABSTRACT

A wearable safety device is disclosed. The device includes a waterproof housing with a touch-based display screen. The device includes dual alarm buttons utilizing, for example, simultaneous actuation to trigger an emergency alert, which initiates an alert message to be transmitted to law enforcement, employer, emergency contact, et. al. (i.e., selected destination) of the wearer of the device along with activation of vibration feedback and automatic audio recording. The device features a GPS receiver/transceiver for location tracking and a wireless module for real-time communication with law enforcement, employer, emergency contact, et. al. (i.e., selected destination). The device connects to a mobile application and cloud database for storing audio/video and receiving predictive safety alerts based on historical data analysis, thereby enhancing user safety through both reactive and preventive measures.

### CROSS-REFERENCE TO RELATED APPLICATION

The present application claims priority to, and the benefit of, U.S. Provisional Application No. 63/561,773, which was filed on Mar. 6, 2024 and is incorporated herein by reference in its entirety.

### FIELD OF THE INVENTION

The present invention generally relates to the field of wearable devices and personal safety devices. More specifically, the present invention relates to a novel safety device that aids in the safety of home healthcare medical staff and any profession where employees are in vulnerable situations. The device helps in providing prompt response from law enforcement, 911 emergency dispatch, employer, and/or emergency contact (i.e., selected destination) of the wearer of the device by sharing the wearer's location. An alarm is activated using alarm buttons and upon activation, police and/or the employer/emergency contact (i.e., selected destination) are notified. The device is linked to an app that enables users to rate their experiences from a safety perspective, sharing insight about high crime areas, aggressive patients, known criminals, and sex offenders. Accordingly, the present disclosure makes specific reference thereto. Nonetheless, it is to be appreciated that aspects of the present invention are also equally applicable to other like applications, devices, and methods of manufacture.

### BACKGROUND

By way of background, many patients, children, and other individuals require care and treatment at their homes. As a result, home healthcare professionals frequently enter residential settings or isolated environments. Also, professionals related to healthcare providers, Child Protective Services (CPS) case workers, realtors, and similar roles visit residential settings or isolated environments for meetings and work. Accordingly, there exists a heightened risk of encountering potentially hazardous situations for such workers and professionals. The risk is increased by the nature of work which often necessitates conducting duties alone and without immediate access to assistance or protective oversight.

When an employee is alone, the capacity to effectively respond to or evade aggressive behaviors or hazardous situations is reduced. Contacting someone such as emergency contacts is ineffective and can exacerbate the threat level. The aggressors or perpetrators may react by intensifying their aggressive behavior, thereby escalating the danger before any external help can be provided. Individuals desire a safety device and system that can effectively enhance the personal safety of individuals operating within high-risk environments.

Therefore, there exists a long felt need in the art for a novel safety device that can be used by healthcare workers, CPS case workers, and more who visit and work at unknown residential settings and isolated areas. There is also a long felt need in the art for a novel wearable device that can be easily activated to alert law enforcement, employer, emergency contact, et. al. (i.e., selected destination) to emergency situations. Additionally, there is a long felt need in the art for a wearable device that provides location and alert information to law enforcement and/or the employer/emergency contact (i.e., selected destination) of the wearer of the device when an emergency is faced by the wearer. Moreover, there is a long felt need in the art for an improved safety device that alerts law enforcement, employer, emergency contact, et. al. (i.e., selected destination) for prompt response and help. Further, there is a long felt need in the art for a safety device that enables users to pair the device with a smartphone application to share insight and experiences between healthcare workers and other employees about dangerous areas and clients. Furthermore, there is a long felt need in the art for a novel wearable device that functions both as a watch and a safety device. Finally, there is a long felt need in the art for a safety device that aids in the safety of home healthcare medical staff and any profession where employees are in vulnerable situations.

The subject matter disclosed and claimed herein, in one embodiment thereof, comprises a wearable safety and emergency response device. The device is in the form of a wearable watch and comprises a waterproof housing shaped to accommodate the wrist of a user using a strap, the housing includes a touch-based display screen capable of displaying time, date, and a battery level of the device. A first alarm button and a second alarm button are located on opposing lateral ends of the housing and the buttons are simultaneously pressed for a predetermined period of time to activate an emergency alarm, wherein upon activation of the emergency alarm causes the housing to vibrate and automatically initiates recording of surrounding audio via at least one microphone integrated into the housing. A GPS receiver/transceiver is included for detecting the location of the wearable device, and a wireless module for communication with law enforcement and/or an employer/emergency contact (i.e., selected destination). The location is shared with the law enforcement personnel and employers of the wearer of the device for facilitating quick help.

In this manner, the wearable safety and emergency response device of the present invention accomplishes all of the forgoing objectives and provides users with a safety and emergency response wearable device that enhances the personal safety and security of individuals in vulnerable working conditions, such as home healthcare workers, CPS case workers, realtors, and others. The device enables users to selectively trigger a silent alarm without needing to access a phone or visibly alert an aggressor, or trigger an alarm that emits a high frequency audible sound. The device integrates multiple safety features such as discreet alarms, location sharing, evidence recording, and community safety insights to offer a holistic approach to personal security unlike any existing solutions. The location sharing facilitates a rapid response, significantly reducing the time taken by law enforcement personnel and employers to arrive at the shared location for help.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wearable safety and emergency response device. The device further comprises a waterproof housing shaped to accommodate the wrist of a user, the housing includes a touch-based display screen capable of displaying time, date, and battery level. A first alarm button and a second alarm button are located on opposing lateral ends of the housing and the buttons utilize, for example, simultaneous depression for a predetermined period of time to activate an emergency alarm, wherein activation of the emergency alarm causes the housing to vibrate and automatically initiates recording of surrounding audio via at least one microphone integrated into the housing. A GPS receiver/transceiver is included for detecting the location of the wearable device, and a wireless module for communication with law enforcement and/or an employer/emergency contact (i.e., selected destination).

In yet another embodiment, a multi-mode wearable safety device is disclosed. The device includes a waterproof housing with a touch-based display screen, a strap equipped with a fastener mechanism for securing the device around a user's wrist, dual alarm buttons are positioned on opposite ends of the housing, the dual alarm buttons are designed to utilize, for example, simultaneous actuation by the user to trigger an emergency alarm, where activation is signified by vibration of the device and transmitting alerts to law enforcement, 911 emergency dispatch, employer, and/or emergency contact (i.e., selected destination) of the wearer of the device, and a connectivity feature to pair the device with a mobile application and a cloud database for storing and sharing recorded audio and/or video, and for receiving community-driven safety alerts based on user location and historical data analysis. The device enables users to selectively trigger simultaneously a silent alarm and the alert without needing to access a phone or visibly alert an aggressor. Alternatively, the device enables users to selectively trigger simultaneously an audible alarm and the alert, wherein the audible alarm emits a high frequency audible sound.

In another aspect, a method for providing predictive safety alerts and emergency assistance using a wearable device is described. The method comprises the steps of detecting the geographic location of the wearable device through an integrated GPS receiver/transceiver, analyzing the detected location against historical data of known safety incidents to assess potential safety threats within a predetermined vicinity of the device, upon identifying a potential safety threat, automatically generating a predictive safety alert to alert law enforcement and/or the employer/emergency contact (i.e., selected destination) of the wearer of the device.

In yet another embodiment, a method for activating an emergency response using a wearable device is disclosed. The method comprises the steps of providing the wearable device, the wearable device includes a housing, two alarm buttons, and a display. The method includes pressing first and second alarm buttons located on opposing lateral ends of a waterproof housing of the wearable device simultaneously for a predetermined period of time or pressing and releasing both the alarm buttons consecutively and simultaneously twice, vibrating the housing to indicate successful activation of an emergency alarm to the wearer, automatically initiating recording of surrounding audio via at least one microphone integrated into the housing upon activation of the emergency alarm, and transmitting the recorded audio and the location of the wearable device in an alert signal, to law enforcement and/or an employer/emergency contact (i.e., selected destination) in real time via a wireless module included in the wearable device.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of the safety and emergency response wearable device of the present invention in accordance with the disclosed structure;

FIG. 2 illustrates a side perspective view of the housing of the safety wearable device of the present invention in accordance with the disclosed structure;

FIG. 3 illustrates a rear perspective view of the housing of the safety and emergency response wearable device of the present invention in accordance with the disclosed structure;

FIG. 4 illustrates a schematic view showing communication of the multi-mode wearable safety device with the safety and community application, and cloud database of the present invention in accordance with the disclosed architecture;

FIG. 5 illustrates a perspective view use of the multi-mode wearable safety device to communicate with law enforcement, employer, emergency contact, et. al. (i.e., selected destination) in case of an emergency in accordance with the disclosed architecture;

FIG. 6 illustrates a flow chart depicting a process of automatic notifying law enforcement and sending audio/video by the safety wearable device in accordance with the disclosed structure;

FIG. 7 illustrates another flow chart depicting a process of alerting law enforcement, employer, emergency contact, et. al. (i.e., selected destination) about a potential threat location for the wearable device in accordance with the disclosed structure; and

FIG. 8 illustrates a perspective of one potential embodiment of the wireless charger dock of the wearable device in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a novel safety device that can be used by healthcare workers, CPS case workers, and more who visit and work at unknown residential settings and isolated areas. There is also a long felt need in the art for a novel wearable device that can be easily activated to alert law enforcement, employer, emergency contact, et. al. (i.e., selected destination) to emergency situations. Additionally, there is a long felt need in the art for a wearable device that provides location and alert to law enforcement and/or the employer/emergency contact (i.e., selected destination) of the wearer of the device when an emergency is faced by the wearer. Moreover, there is a long felt need in the art for an improved safety device that alerts law enforcement, employer, emergency contact, et. al. (i.e., selected destination) for prompt response and help. Further, there is a long felt need in the art for a safety device that enables users to pair the device with a smartphone application to share insight and experiences between healthcare workers and other employees about dangerous areas and clients. Furthermore, there is a long felt need in the art for a novel wearable device that functions both as a watch and a safety device. Finally, there is a long felt need in the art for a safety device that aids in the safety of home healthcare medical staff and any profession where employees are in vulnerable situations.

The present invention, in one exemplary embodiment, is a method for activating an emergency response using a wearable device. The method comprises the steps of providing the wearable device, the wearable device includes a housing, two alarm buttons, and a display. The method includes pressing first and second alarm buttons located on opposing lateral ends of a waterproof housing of the wearable device simultaneously for a predetermined period of time or pressing and releasing both the alarm buttons consecutively and simultaneously twice, vibrating the housing to indicate successful activation of an emergency alarm to the wearer, automatically initiating recording of surrounding audio via at least one microphone integrated into the housing upon activation of the emergency alarm, and transmitting the recorded audio and the location of the wearable device in an alert signal, to law enforcement and/or an employer/emergency contact in real time via a wireless module included in the wearable device.

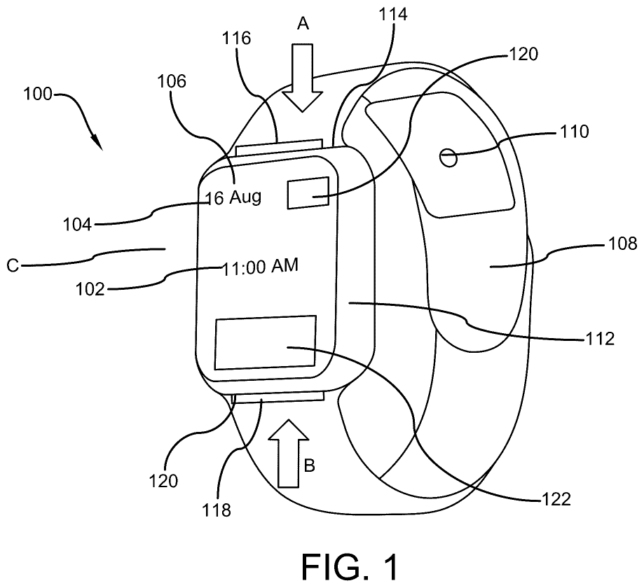

Referring initially to the drawings, FIG. 1 illustrates a perspective view of the safety and emergency response wearable device of the present invention in accordance with the disclosed structure. The safety and emergency response wearable device 100 of the present invention is designed as a comprehensive security and safety system and mimics the appearance and functionality of a smartwatch. The safety wearable device 100 is designed for enhancing the safety protocols for home healthcare medical staff or any other environs, but application of the device 100 can extend to any profession where employee safety is a concern. It is to be appreciated that the device 100 can be used to alert and record during any encounter, assault, or episode in order to send an alert for help and to memorialize the encounter for evidence. More specifically, the wearable device 100 functions as a standard smartwatch and offers time display 102 and date display 104 on a touch-based display screen 106. The touch-based display screen 106 can be one or more of OLED, AMOLED, LCD, E-Ink, and more. The touch-based display screen 106 can also be flexible or bendable and made using plastic substrates instead of glass.

The wearable device 100 includes a strap 108 for securing the device 100 around wrist of a user. The strap 108 can include a fastener 110 for securing the wearable device 100. The fastener 110 can include but not be limited to a buckle clasp, a magnetic clasp, a hook and loop clasp, a snap-fit, a tension fit, and a slide and lock mechanism.

The display 106 and the other electronic components (along with circuitry) is housed in a waterproof housing 112. The housing 112 can have any geometric shape to accommodate requirements of different users. The one lateral end 114 of the housing 112 has a first alarm button 116 thereon. The first alarm button 116 is adapted to be pushed manually by a user towards the housing 112 as indicated by the arrow “A”. A second alarm button 118 is disposed on the second lateral end 120 of the housing 112 and is also adapted to be pushed by the user towards the housing 112 as indicated by the arrow “B”. Preferably, both the alarm buttons 116, 118 of the wearable device 100 are to be pressed by a user in a specific manner or sequence to generate an alarm/alert, wherein the alarm is sent via the transceiver in real-time to law enforcement, 911 emergency dispatch, employer, and/or emergency contact (i.e., selected destination) of the wearer of the wearable device 100.

In the preferred embodiment, the alarm buttons 116, 118 can be pressed simultaneously for a predetermined period of time such as three seconds for activating the alarm. Alternatively, both the alarm buttons 116, 118 can be pressed and released consecutively and simultaneously twice for activating the alarm. Different positions and simultaneous actuation of both the buttons 116, 118 prevents accidental activation of the alarm from the device 100. When an alarm is activated, the housing 112 vibrates (indicated by arrow “C”) for indicating to the wearer about successful activation of the alarm. The device enables users to selectively trigger simultaneously a silent alarm and the alert using alarm buttons 116, 118 without needing to access a phone or visibly alert an aggressor. Alternatively, the device enables users to selectively trigger simultaneously an audible alarm and the alert using alarm button 119, wherein the audible alarm emits a high frequency audible sound through a speaker 121.

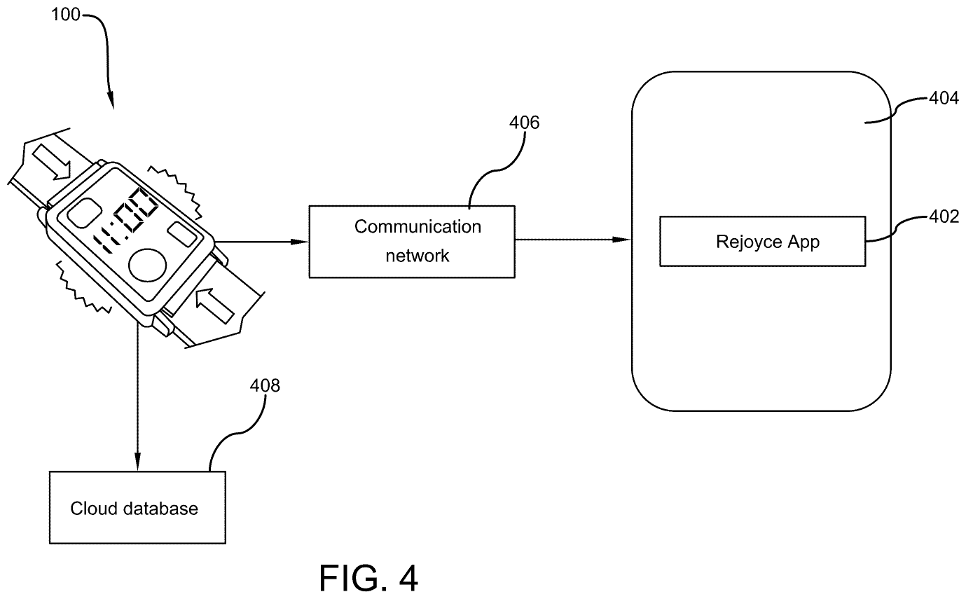

The display 106 is also adapted to display battery level 120 of the wearable device 100 and display active connection indication 122 of the wearable device 100 with a corresponding application which is described in FIG. 4. The wearable device 100 can be preconfigured by an employer/emergency contact such as a medical care service provider, hospital, or any other employer for their employees for safety of the employees. The law enforcement connected to the device 100 can be one or both of local and central law enforcement.

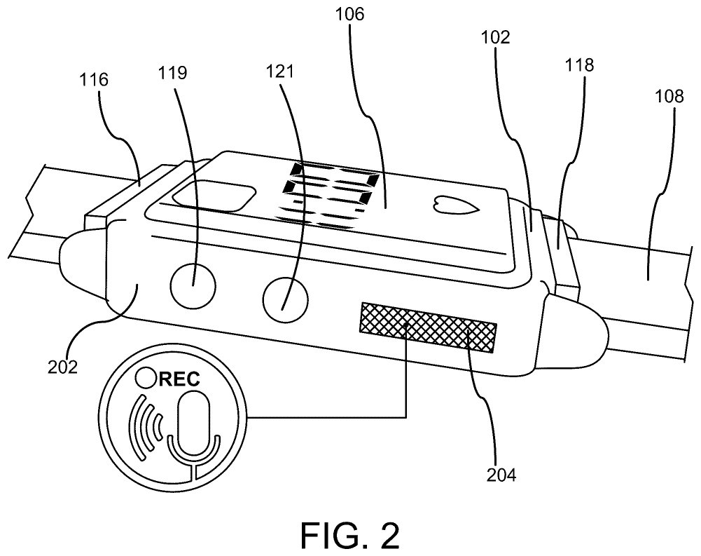

FIG. 2 illustrates a side perspective view of the housing of the safety wearable device of the present invention in accordance with the disclosed structure. One side surface 202 of the housing 112 includes at least one microphone 204 for recording surrounding audio. The microphone 204 is automatically activated when an alarm is successfully activated. In the preferred embodiment, the recorded audio is also sent to the law enforcement, employer, emergency contact, et. al. (i.e., selected destination) in real time.

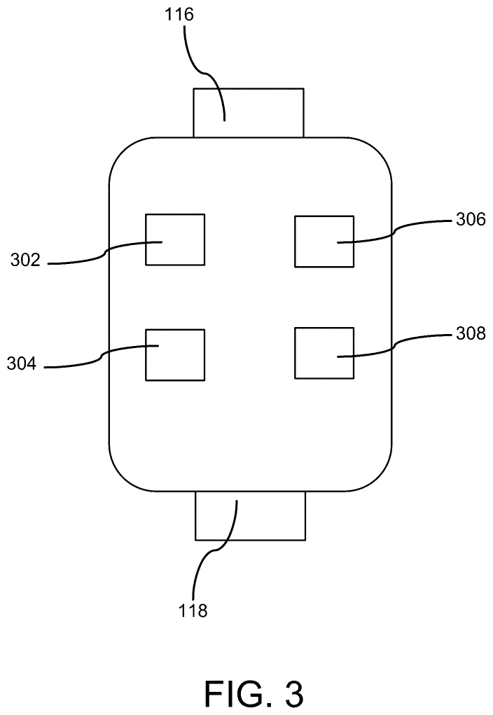

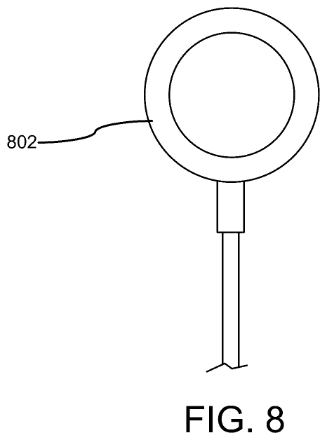

FIG. 3 illustrates a rear perspective view of the housing of the safety and emergency response wearable device of the present invention in accordance with the disclosed structure. The housing 112 is waterproof and provides a sealed environment to the electronic components stored therein. A GPS receiver/transceiver 302 is included in the multi-mode wearable safety device 100 for detecting location of the wearable device 100 (and the wearer). The location is used for providing immediate help and prompt response by law enforcement, employer, emergency contact, et. al. (i.e., selected destination). A battery 304 is included in the housing 112 for providing electrical power for functioning of the device 100. The battery 304 is preferably a button battery but can be any type of conventional battery and can also be solar powered. The battery 304 can be recharged using a wired medium or the battery 304 can also be charged wirelessly using a charger 802 as illustrated in FIG. 8.

A wireless module 306 is included in the device 100 for providing wireless communication to law enforcement and/or an employer/emergency contact (i.e., selected destination). In some embodiments, the device 100 can be paired with one or more additional devices such as of other nearby employees of the same employer for safety of the wearer. A vibrator 308 is adapted to create vibrations in the housing 112 when the alarm buttons 116, 118 are pressed together, or button 119 is actuated, as described earlier in the disclosure.

FIG. 4 illustrates a schematic view showing communication of the multi-mode wearable safety device with the safety and community application, and cloud database of the present invention in accordance with the disclosed architecture. As illustrated, the wearable device 100 is connected to the safety and community application 402 which is also referred to as the Rejoyce application. The application 402 is installed in a handheld electronic device 404 such as a smartphone or any other portable electronic device. The wearable device 100 and the application 402 are connected using the wireless channel 406 for enabling the device 100 to send notification to the application 402. The wearable device 100 is also coupled to a cloud database 408 which is adapted to store the audio and/or video from the device 100. The recordings in the cloud database 408 can be accessed by law enforcement, employer, emergency contact, et. al. (i.e., selected destination) for monitoring and implementing regulations.

The application 402 also enables users to provide feedback on their safety experiences. The feedback is used for sharing insights into areas with high crime rates, aggressive behavior, known criminals, or sex offenders, thus fostering a community-driven approach to safety. The application can use advanced algorithms that predict potential danger based on the user's location and historical data stored in the application and cloud storage 408. The application 402 can send an instruction signal to the device 100 when the device 100 is at such a location to indicate to the wearer of the potential threat with the location.

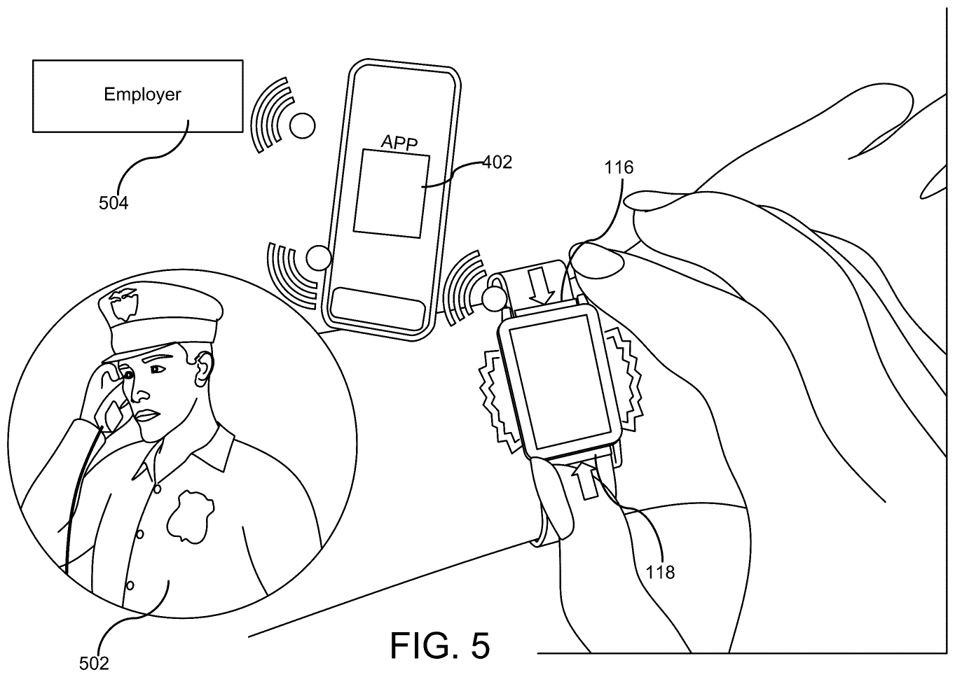

FIG. 5 illustrates a perspective view of the use of a multi-mode wearable safety device 100 to communicate with law enforcement, employer, emergency contact, et. al. (i.e., selected destination) in case of an emergency or encounter in accordance with the disclosed architecture. As illustrated, when the alarm buttons 116, 118 are pressed simultaneously, the device 100 communicates with the law enforcement 502 via the application 402. The application 402 is connected to the device 100 as described in FIG. 4 and the application 402 upon receiving an alarm/alert indication from the device 100, provides an alarm/alert in the form of an audio call, message, text message, video call, or any other communication means using the communication channel 406 to the law enforcement 502 and/or the employer/emergency contact (i.e., selected destination) 504 for providing prompt response to the wearer.

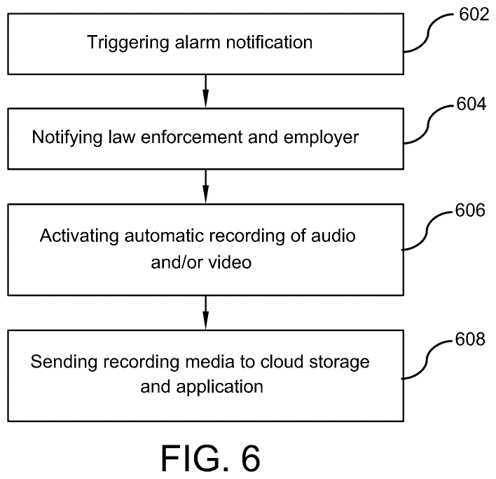

FIG. 6 illustrates a flow chart depicting a process of automatic notifying law enforcement and sending audio/video by the safety wearable device in accordance with the disclosed structure. Initially, an alarm notification is triggered using the alarm button 116, 118 (Step 602). The device enables users to selectively trigger simultaneously a silent alarm and the alert without needing to access a phone or visibly alert an aggressor. Alternatively, the device enables users to selectively trigger simultaneously an audible alarm and the alert, wherein the audible alarm emits a high frequency audible sound. Then, at least law enforcement and/or the employer/emergency contact (i.e., selected destination) of the wearer are notified via the application 402 for providing prompt response to the wearer of the wearable device (Step 604). Then, automatic recording of the surrounding audio and possibly, video (using a camera integrated in the device 100) is initiated by the application (Step 606). Finally, the audio and video from the device 100 are sent to the application 402 and the cloud storage 408 in real-time for monitoring.

In some embodiments, the wearable device 100 is adapted to vibrate in different frequencies when law enforcement or employer or any other help is reaching the wearer of the device 100. The vibration can depend on the distance of the law enforcement or employer from the device 100 and can provide an assurance to the wearer of the safety wearable device 100.

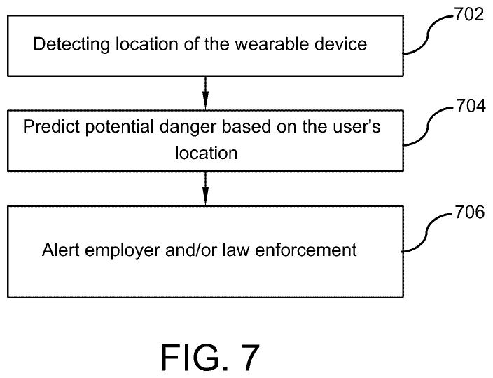

FIG. 7 illustrates another flow chart depicting a process of alerting law enforcement, employer, emergency contact, et. al. (i.e., selected destination) about a potential threat location for the wearable device in accordance with the disclosed structure. In the present embodiment, location of the wearable device 100 is detected by the GPS receiver/transceiver 302 and may also be sent to the paired application (Step 702). Then, based on the location of the device 100 and on the historical data of the location, potential danger is predicted by the device (Step 704). In some embodiments, a 300 meter, for example, periphery of the location of the device 100 is considered to predict the potential threat. Based on the intensity of the potential threat, law enforcement, employer, emergency contact, et. al. (i.e., selected destination) are alerted and notified by the user (Step 706) for prompt response and help.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “safety and emergency response wearable device”, “safety wearable device”, “wearable device”, “multi-mode wearable safety device”, and “device” are interchangeable and refer to the safety and emergency response wearable device 100 of the present invention.

Notwithstanding the forgoing, the safety and emergency response wearable device 100 of the present invention can be of any suitable size and configuration as is known in the art without affecting the overall concept of the invention, provided that it accomplishes the above stated objectives. One of ordinary skill in the art will appreciate that the safety and emergency response wearable device 100 as shown in the FIGS. are for illustrative purposes only, and that many other sizes and shapes of the safety and emergency response wearable device 100 are well within the scope of the present disclosure. Although the dimensions of the safety and emergency response wearable device 100 are important design parameters for user convenience, the safety and emergency response wearable device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety wearable device comprising:
a wearable device;
a housing;
a touch-based display screen;
a first alarm button;
a second alarm button;
a strap;
a fastener;
a battery; and
a transceiver;
wherein said strap securable with said fastener around a wrist of a user;
wherein said touch-based display screen housed in said housing;
wherein said first alarm button manually actuated by the user;
wherein said first alarm button actuated towards said housing;
wherein said second alarm button manually actuated by the user;
wherein said second alarm button actuated towards said housing;
wherein actuating at least one of said first alarm button and said second alarm button sends an alert to a destination through said transceiver; and
further wherein said destination of said alert is selected from the group consisting of a law enforcement, a 911 emergency dispatch, an employer, and an emergency contact of the user of said wearable device.

2. The safety wearable device of claim 1 further comprising a microphone, wherein upon actuating at least one of said first alarm button and said second alarm button said microphone initiates audio recording.

3. The safety wearable device of claim 2, wherein said audio recording is sent in real time to said destination.

4. The safety wearable device of claim 1, wherein actuating said first alarm button and said second alarm button simultaneously sends said alert through said transceiver.

5. The safety wearable device of claim 4, wherein actuating said first alarm button and said second alarm button simultaneously is for a predetermined period of time.

6. The safety wearable device of claim 5, wherein said battery is rechargeable.

7. The safety wearable device of claim 6, wherein said touch-based display screen having a time display and a date display.

8. The safety wearable device of claim 7, wherein said touch-based display screen having a flexible screen.

9. The safety wearable device of claim 8, wherein said touch-based display screen selected from the group consisting of one or more of an OLED, an AMOLED, an LCD, and an E-Ink.

10. The safety wearable device of claim 9, wherein said fastener selected from the group consisting of a buckle clasp, a magnetic clasp, a hook and loop clasp, a snap-fit, a tension fit, and a slide and lock mechanism.

11. The safety wearable device of claim 1, wherein said transceiver having a GPS receiver for detecting a location of said wearable device.

12. A safety wearable device comprising:
a wearable device;
a housing;
a touch-based display screen;
a first alarm button;
a second alarm button;
a strap;
a fastener;
a battery;
a vibrator; and
a transceiver;
wherein said strap securable with said fastener around a wrist of a user;
wherein said touch-based display screen housed in said housing;
wherein said first alarm button manually actuated by the user;
wherein said second alarm button manually actuated by the user;
wherein actuating said first alarm button and said second alarm button sends an alert to a destination through said transceiver;
wherein actuating said first alarm button and said second alarm button actuates said vibrator for confirming sending said alert to said destination; and
further wherein said destination of said alert is selected from the group consisting of a law enforcement, a 911 emergency dispatch, an employer, and an emergency contact of the user of said wearable device.

13. The safety wearable device of claim 12 further comprising a microphone, wherein upon actuating at least one of said first alarm button and said second alarm button said microphone initiates audio recording.

14. The safety wearable device of claim 13, wherein said audio recording is sent in real time to said destination.

15. The safety wearable device of claim 14, wherein actuating said first alarm button and said second alarm button simultaneously sends said alert through said transceiver.

16. A method of actuating an alert, the method comprising the following steps:
providing a wearable device, a housing, a first alarm button, a second alarm button, a third alarm button, a strap, a fastener, a battery, a vibrator, and a transceiver;
fastening said wearable device with said strap and said fastener around a wrist of a user;
manually selectively actuating said first alarm button by the user;
manually selectively actuating said second alarm button by the user;
manually selectively actuating said third alarm button by the user;
sending an alert to a destination through said transceiver; and
actuating said vibrator for confirming sending said alert to said destination.

17. The method of actuating an alert of claim 16, wherein said destination of said alert is selected from the group consisting of a law enforcement, a 911 emergency dispatch, an employer, and an emergency contact of the user of said wearable device.

18. The method of actuating an alert of claim 17, wherein upon actuating said first alarm button and said second alarm button actuates a microphone for audio recording.

19. The method of actuating an alert of claim 18, wherein said audio recording is sent in real time to said destination.

20. The method of actuating an alert of claim 19, wherein actuating said third alarm button simultaneously sends said alert through said transceiver and emits an audible alarm from said wearable device.
